(19) United States
(12) Patent Application Publication
(10) Pub. No.: US 2026/0153377 A1
(43) Pub. Date: Jun. 4, 2026

(54) EQUIPMENT ABNORMALITY DIAGNOSIS METHOD, CONTROL DEVICE, AND EQUIPMENT ABNORMALITY DIAGNOSIS SYSTEM INCLUDING THE SAME

(71) Applicant: Samsung Display Co., Ltd., Yongin-Si (KR)

(72) Inventors: SEONGHYEON PARK, Yongin-si (KR); TAEWOO KANG, Yongin-si (KR); SUIN KO, Yongin-si (KR); JANGKYU KIM, Yongin-si (KR); HOYOUN JANG, Yongin-si (KR); KYUNGSUK CHOI, Yongin-si (KR)

(21) Appl. No.: 19/391,375

(22) Filed: Nov. 17, 2025

(30) Foreign Application Priority Data
Nov. 21, 2024 (KR) 10-2024-0167763

(51) Int. Cl. G01H 1/12; G06F 18/213

(52) U.S. Cl. CPC G01H 1/12; G06F 18/213; G06F 2218/10

(57) ABSTRACT

Provided are an equipment abnormality diagnosis method, a control device, and an equipment abnormality diagnosis system including the same, wherein the equipment abnormality diagnosis method includes obtaining a waveform signal from a sensor unit configured to detect vibration of equipment to be diagnosed, extracting a calculated representative value based on the waveform signal, selecting a shape data corresponding to the calculated representative value by using a plurality of pre-stored shape models, and diagnosing an abnormal state of the equipment based on a type of the selected shape data.

### CROSS-REFERENCE TO RELATED APPLICATION

This application is based on and claims priority under 35 U.S.C. § 119 to Korean Patent Application No. 10-2024-0167763, filed on Nov. 21, 2024, in the Korean Intellectual Property Office, the disclosure of which is incorporated by reference herein in its entirety.

### BACKGROUND

### 1. Field

Embodiments of the disclosure relate to an equipment abnormality diagnosis method, a control device, and an equipment abnormality diagnosis system including the same.

### 2. Description of the Related Art

Mobile electronic devices are widely used. Recently, tablet personal computers (PCs), in addition to small-sized electronic devices such as mobile phones, have been widely used as mobile electronic devices.

To support various functions, such mobile electronic devices include display devices to provide visual information, such as an image or a video, to a user. Recently, with the miniaturization of components for driving the display devices, proportions of the display devices occupying the electronic devices are gradually increasing, and the display devices having structures that are bendable from flat states to have certain angles are also being developed.

The display devices may display an image by altering a molecular arrangement of liquid crystals by applying a voltage, and changing optical properties, such as birefringence, rotatory polarization, dichroism, and light scattering characteristics of liquid crystal cells that emit light according to the change in the molecular arrangement.

For equipment for transferring an electronic device such as the above display device, it is important to accurately arrange all or a portion of the electronic device at a designated location. In particular, when precise location adjustment is not achieved while transferring the electronic device, assembly quality or operational reliability may deteriorate, and thus, it is required to stably and precisely place the electronic device.

Accordingly, precisely monitoring, in real time, an abnormal state that may occur in the equipment for transferring the electronic device is essential to maintain stability of the equipment and quality of a product, and a monitoring technology for efficiently detecting a minute error or abnormal movement, which may occur during the transfer, is required.

The aforementioned background technology is technical information possessed by the inventor before derivation of an inventive concept or acquired by the inventor during the derivation of the inventive concept, and is not necessarily prior art disclosed to the public before the application of the disclosure.

### SUMMARY

Embodiments of the disclosure provide an equipment abnormality diagnosis method, a control device, and an equipment abnormality diagnosis system including the same, in which an abnormal state of equipment may be efficiently determined.

Aspects of the disclosure are not limited to those mentioned above, and other aspects and advantages of the disclosure, which are not mentioned, will be understood from descriptions below and will become more apparent by embodiments of the disclosure. In addition, the aspects and advantages of the disclosure will be realized through means and combinations thereof in the claims.

An embodiment of the disclosure provides an equipment abnormality diagnosis method including obtaining a waveform signal from a sensor unit configured to detect vibration of equipment to be diagnosed, extracting a calculated representative value based on the waveform signal, selecting a shape data corresponding to the calculated representative value by using a plurality of pre-stored shape models, and diagnosing an abnormal state of the equipment based on a type of the selected shape data.

In an embodiment, the extracting of the calculated representative value may include extracting one calculated representative value from each of a plurality of first unit waveforms included in the waveform signal in a first time unit.

In an embodiment, the one calculated representative value may be greater than or equal to.

In an embodiment, the extracting of the calculated representative value may include extracting the calculated representative value by using a size of each of the plurality of first unit waveforms.

In an embodiment, the selecting of the shape data may include selecting one shape data corresponding to each of a plurality of second unit waveforms included in the waveform signal in a second time unit.

In an embodiment, the second time unit may be relatively greater than the first time unit.

In an embodiment, the selecting of the shape data may include selecting one shape data corresponding to the each of the plurality of second unit waveforms, based on the calculated representative value of the plurality of first unit waveforms temporally overlapping the plurality of second unit waveforms.

In an embodiment, the selecting of the shape data may include selecting the shape data by comparing sizes of a plurality of calculated representative values that are temporally adjacent to each other and included in a same second unit waveform.

In an embodiment, the diagnosing of the abnormal state of the equipment may include diagnosing the abnormal state of the equipment by comparing types of the shape data of the plurality of second unit waveforms that are temporally adjacent to each other.

In an embodiment, the diagnosing of the abnormal state of the equipment may include determining that the abnormal state has occurred in the equipment when the types of the shape data of the plurality of second unit waveforms that are temporally adjacent to each other are different from each other.

An embodiment of the disclosure provides a control device including at least one memory and at least one processor, wherein the at least one processor is configured to obtain a waveform signal from a sensor unit configured to detect vibration of equipment to be diagnosed, extract a calculated representative value based on the waveform signal, select a shape data corresponding to the calculated representative value by using a plurality of pre-stored shape models, and diagnose an abnormal state of the equipment based on a type of the determined shape data.

In an embodiment, the at least one processor may be further configured to extract one calculated representative value from each of a plurality of first unit waveforms included in the waveform signal in a first time unit.

In an embodiment, the at least one processor may be further configured to extract the calculated representative value by using a size of each of the plurality of first unit waveforms.

In an embodiment, the at least one processor may be further configured to select one shape data corresponding to each of a plurality of second unit waveforms included in the waveform signal in a second time unit.

In an embodiment, the at least one processor may be further configured to diagnose the abnormal state of the equipment by comparing types of the shape data of the plurality of second unit waveforms that are temporally adjacent to each other.

An embodiment of the disclosure provides an equipment abnormality diagnosis system including equipment configured to transfer and/or return all or a portion of an electronic device, a sensor unit configured to detect vibration of the equipment to be diagnosed, and a control device configured to obtain a waveform signal including information about the vibration of the equipment from the sensor unit and diagnose an abnormal state of the equipment, wherein the control device is further configured to obtain the waveform signal from the sensor unit, extract a calculated representative value based on the waveform signal, select a shape data corresponding to the calculated representative value by using a plurality of pre-stored shape models, and diagnose the abnormal state of the equipment based on a type of the selected shape data.

In an embodiment, the control device may be further configured to extract one calculated representative value from each of a plurality of first unit waveforms included in the waveform signal in a first time unit.

In an embodiment, the control device may be further configured to extract the calculated representative value by using a size of each of the plurality of first unit waveforms.

In an embodiment, the control device may be further configured to select one shape data corresponding to each of a plurality of second unit waveforms included in the waveform signal in a second time unit.

In an embodiment, the control device may be further configured to diagnose the abnormal state of the equipment by comparing types of the shape data of the plurality of second unit waveforms that are temporally adjacent to each other.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically showing an equipment abnormality diagnosis system according to an embodiment of the disclosure;

FIG. 2 is a block diagram of a control device shown in FIG. 1;

FIG. 3 is a flowchart of an equipment abnormality diagnosis method according to an embodiment of the disclosure;

FIG. 4 is a diagram for describing obtaining of a waveform signal from a sensor unit shown in FIG. 3;

FIG. 5 is a diagram for describing extracting of a calculated representative value of the waveform signal shown in FIG. 3;

FIG. 6 is a diagram for describing a process of calculating a shape calculation function by using a calculated representative value;

FIG. 7 is a diagram for describing a process of selecting shape data by using a shape calculation function;

FIG. 8 is a diagram schematically illustrating a display device capable of being transferred to equipment shown in FIG. 1; and

FIG. 9 is a cross-sectional view of a sub-pixel of the display device of FIG. 8.

### DETAILED DESCRIPTION

The disclosure may have various modifications and various embodiments, and specific embodiments are illustrated in the drawings and are described in detail in the detailed description. Effects and features of the disclosure and methods of achieving the same will become apparent with reference to embodiments described in detail with reference to the drawings. However, the disclosure is not limited to the embodiments described below, and may be implemented in various forms.

In the following embodiments, the terms “first” and “second” are not used in a limited sense and are used to distinguish one component from another component.

In the following embodiments, an expression used in the singular encompasses the expression of the plural, unless it has a clearly different meaning in the context.

In the following embodiments, it will be further understood that the terms “comprise” and/or “comprising” used herein specify the presence of stated features or components, but do not preclude the presence or addition of one or more other features or components.

In the following embodiments, it will be understood that when a unit, region, or element is referred to as being “formed on” another unit, area, or element, it can be directly or indirectly formed on the other unit, region, or element. That is, for example, intervening units, regions, or elements may be present.

In the following embodiments, terms such as connect or combine do not necessarily imply a direct and/or fixed connection or combination of two members, unless the context clearly indicates otherwise, and do not exclude the presence of another member between the two members.

In the drawings, for convenience of description, sizes of components may be exaggerated or reduced. For example, because sizes and/or thicknesses of components in the drawings are arbitrarily illustrated for convenience of explanation, the disclosure is not necessarily limited thereto.

Hereinafter, embodiments of the disclosure will be described in detail with reference to the accompanying drawings, and in the following description with reference to the drawings, like reference numerals refer to like or corresponding components and redundant descriptions thereof will be omitted.

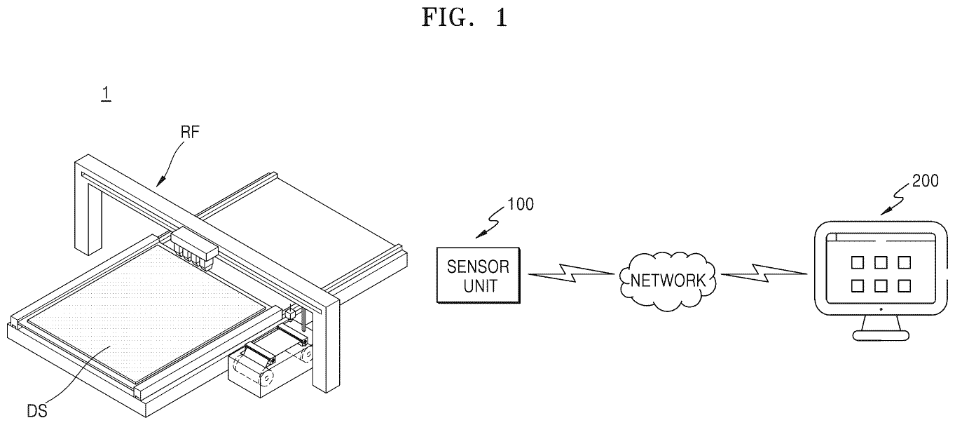

FIG. 1 is a diagram schematically showing an equipment abnormality diagnosis system 1 according to an embodiment of the disclosure.

Referring to FIG. 1, the equipment abnormality diagnosis system 1 according to an embodiment of the disclosure may include equipment RF, a sensor unit 100, and a control device 200.

The equipment RF is a device configured to transfer and/or return all or a part of an electronic device, and may transfer or return a display device DS while manufacturing the electronic device including the display device DS.

However, the disclosure is not limited thereto and the equipment RF may include various devices capable of transferring or returning substrates, wafers, or the like.

The equipment RF may perform triaxial linear movement or rotational movement by receiving power from an external source.

In an embodiment, the equipment RF may be a transfer device such as a stock (STK) rack master configured to transfer or return the display device DS and, for example, the equipment RF may include at least one of a drive motor, a reducer, and a gear assembly.

The sensor unit 100 may detect vibration occurring in the equipment RF and obtain sensor data SD including information about the vibration of the equipment RF.

The sensor unit 100 may be attached to one side of the equipment RF, but is not limited thereto, and the sensor unit 100 may be spaced apart from the equipment RF at a preset interval and obtain the sensor data SD including the information about the vibration occurred in the equipment RF.

The sensor unit 100 may include various devices capable of obtaining the information about the vibration of the equipment RF and, for example, the sensor unit 100 may include at least one of an accelerometer, a gyroscope sensor, a vibration pickup, a laser vibration sensor, a piezoelectric vibration sensor, an ultrasonic vibration sensor, a strain gauge, a capacitive vibration sensor, a microphone, a magnetic vibration sensor, a photo sensor, a photo transistor, an acoustic emission sensor, a magnetostrictive sensor, and a laser Doppler vibrometer.

The sensor unit 100 may selectively obtain only low-frequency or medium-frequency vibration frequencies between 5 Hz and 100 Hz among vibration frequencies generated in the equipment RF.

The sensor unit 100 may include a low-frequency vibration sensor capable of selectively obtaining only low-frequency frequencies and, for example, the sensor unit 100 may include at least one of a filtered accelerometer with a built-in bandpass filter, a low-frequency response vibration sensor, a fiber optic vibration sensor, a low-frequency piezoelectric vibration sensor, a capacitive low-frequency vibration sensor, and a resonance-based low-frequency sensor.

The sensor unit 100 may obtain the sensor data SD and transmit the sensor data SD to the control device 200, and the control device 200 may determine an abnormal state of the equipment RF by using the sensor data SD obtained from the sensor unit 100.

A method by which the control device 200 determines the abnormal state of the equipment RF by using the sensor data SD will be described in detail with reference to an equipment abnormality diagnosis method described below.

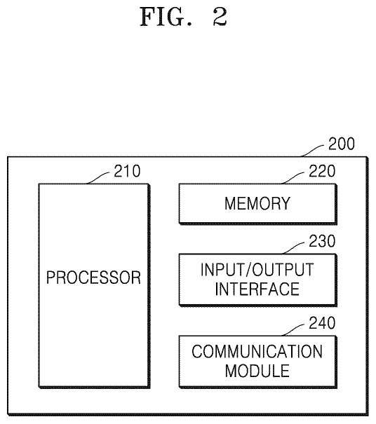

FIG. 2 is a block diagram of the control device 200 shown in FIG. 1.

Referring to FIGS. 1 and 2, the control device 200 according to an embodiment of the disclosure obtains the sensor data SD from the sensor unit 100 and diagnoses an abnormal state of the equipment RF, and may include a processor 210, a memory 220, an input/output interface 230, and a communication module 240.

At least one control device 200 and the processor 210 of the at least one control device 200 may perform an equipment abnormality diagnosis method described below, and the equipment abnormality diagnosis method performed by the control device 200 and the processor 210 of the control device 200 will be described in detail with reference to the equipment abnormality diagnosis method according to an embodiment of the disclosure described below.

The control device 200 includes the processor 210, the memory 220, the input/output interface 230, and the communication module 240. For convenience of description, only components related to the disclosure are illustrated in FIG. 2.

Accordingly, in addition to the components illustrated in FIG. 2, other general-purpose components may be further included in the control device 200. In addition, it would be obvious to one of ordinary skill in the art that the processor 210, the memory 220, the input/output interface 230, and the communication module 240 illustrated in FIG. 2 may be implemented as independent devices.

The processor 210 may be configured to process a command of a computer program by performing basic arithmetic, logic, and input/output operations. Here, the command may be provided from the memory 220 or an external device. Also, the processor 210 may generally control operations of other components included in the control device 200.

For example, the processor 210 may match at least one piece of source data respectively to at least one request that may occur in a specific domain.

Also, the processor 210 may retrieve correct context included in the source data for each request based on a result of the matching.

Also, the processor 210 may generate a database for adaptation to a domain based on the correct context for each request.

In addition, the processor 210 may use the database to generate a response to a request of a user.

The processor 210 may be implemented as an array of a plurality of logic gates, or as a combination of a general-purpose microprocessor and the memory 220 storing a program executable by the general-purpose microprocessor.

For example, the processor 210 may include a general-purpose processor, a central processing unit (CPU), a microprocessor, a digital signal processor (DSP), a controller, a microcontroller, a state machine, and the like. In some environments, the processor 210 may include an application-specific semiconductor (ASIC), a programmable logic device (PLD), a field programmable gate array (FPGA), or the like.

For example, the processor 210 may refer to a combination of processing devices, such as a combination of a DSP and a microprocessor, a combination of a plurality of microprocessors, a combination of one or more microprocessors coupled with a DSP core, or a combination of any other such components.

The memory 220 may include any non-transitory computer-readable recording medium. In an embodiment, the memory 220 may include a permanent mass storage device, such as random access memory (RAM), read-only memory (ROM), disk drive, solid state drive (SSD), or flash memory. In another example, the permanent mass storage device, such as ROM, SSD, flash memory, or disk drive, may be a separate permanent storage device distinguished from the memory 220. An operating system (OS) and at least one program code may be stored in the memory 220.

Such software components may be loaded from a computer-readable recording medium separate from the memory 220. The separate computer-readable recording medium may be a recording medium that may be directly connected to the control device 200, and for example, may include an input/output computer-readable recording medium such as floppy drive, disk, tape, DVD/CD-ROM drive, or memory card.

The software components may be loaded into the memory 220 through the communication module 240 instead of the computer-readable recording medium. For example, at least one program may be loaded on the memory 220 based on a computer program installed by files provided by developers or a file distribution system distributing an application installation file through the communication module 240.

The input/output interface 230 may be a unit for interfacing with a device (e.g., a keyboard, a mouse, or the like) for input and/or output, which may be connected to or included in the control device 200.

In FIG. 2, the input/output interface 230 is illustrated as an element configured separately from the processor 210, but is not limited thereto, and the input/output interface 230 may be included in the processor 210.

The communication module 240 may provide a configuration or function enabling the control device 200 to communicate with an external device such as the sensor unit 100 through a network. In addition, the communication module 240 may provide a configuration or function enabling the control device 200 to communicate with other external devices.

For example, control signals, commands, data, or the like provided under control by the processor 210 may be transmitted to an external device through the communication module 240 and the network.

In an embodiment, the control device 200 may include a display module (not shown). For example, the display module may display, to the user, a response generated for a request of the user.

Referring to FIG. 1, the control device 200 may communicate with the sensor unit 100 through the network.

The control device 200 may obtain the sensor data SD from the sensor unit 100 through the network and the control device 200 may diagnose an abnormal state of the equipment RF by using a waveform signal WD of vibration of the equipment RF included in the sensor data SD.

The control device 200 may generate an alarm signal based on a result of diagnosing the abnormal state of the equipment RF.

The sensor unit 100 and the control device 200 may communicate with each other and/or with another device through the network. The network is a comprehensive data communication network that allows different entities to communicate smoothly with each other, and may include wired Internet, wireless Internet, and a mobile wireless communication network.

For example, the network may include a local area network (LAN), a wide area network (WAN), a value-added network (VAN), a mobile radio communication network, a satellite communication network, or a combination thereof.

Examples of wireless communication may include wireless LAN (Wi-Fi), Bluetooth, Bluetooth low energy, ZigBee, Wi-Fi direct (WFD), ultra-wideband (UWB), infrared data association (IrDA), and near field communication (NFC), but are not limited thereto.

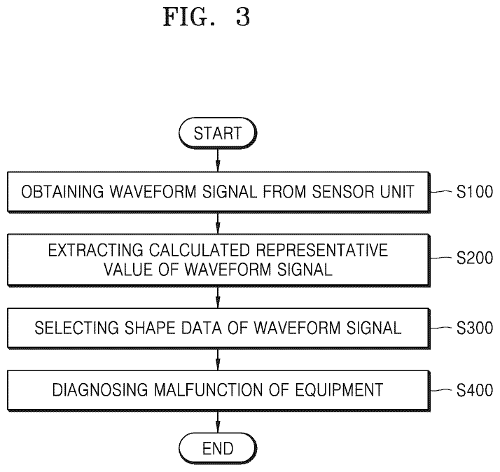

FIG. 3 is a flowchart of an equipment abnormality diagnosis method according to an embodiment of the disclosure.

Referring to FIG. 3, the equipment abnormality diagnosis method according to an embodiment of the disclosure may include obtaining the waveform signal WD from the sensor unit 100 configured to detect vibration of the equipment RF to be diagnosed (operation S100), extracting a calculated representative value ROV based on the waveform signal WD (operation S200), selecting shape data SD corresponding to the calculated representative value ROV by using a plurality of pre-stored shape models SM (operation S300), and diagnosing an abnormal state of the equipment RF, for example, a malfunction of equipment, based on a shape of the selected shape data SD(operation S400).

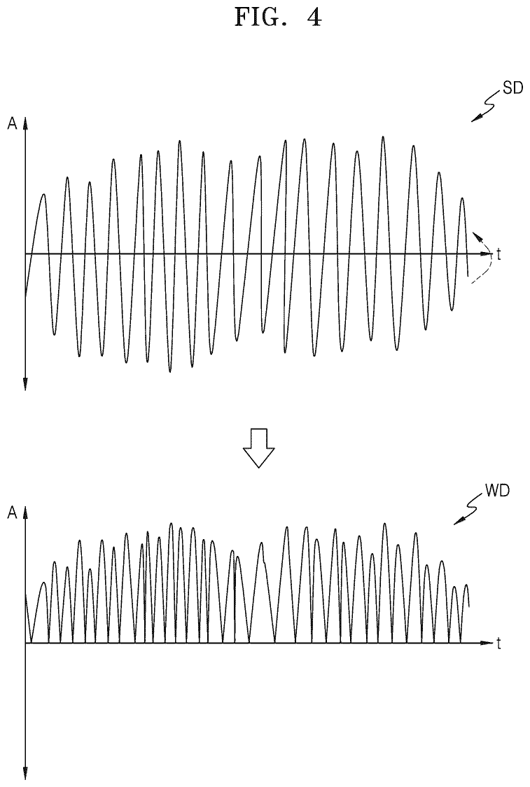

FIG. 4 is a diagram for describing the obtaining of the waveform signal WD from the sensor unit 100 shown in FIG. 3 (operation S100).

Referring to FIGS. 3 and 4, in the obtaining of the waveform signal WD from the sensor unit 100 (operation S100), the control device 200 may obtain the sensor data SD from the sensor unit 100 and convert the sensor data SD into the waveform signal WD.

In the present specification, the sensor data SD may be a vibration waveform of the equipment RF and, specifically, the sensor data SD may be a vibration wave of the equipment RF according to time.

While converting the sensor data SD into the waveform signal WD, the control device 200 may rectify the sensor data SD by applying an absolute value to the sensor data SD.

Accordingly, the control device 200 converts a size of the sensor data SD into a positive value, and thus, only a vibration size of the equipment RF may be considered regardless of a vibration direction of the equipment RF. Thus, the control device 200 may diagnose an abnormal state of the equipment RF by using the vibration size and a vibration pattern of the equipment RF.

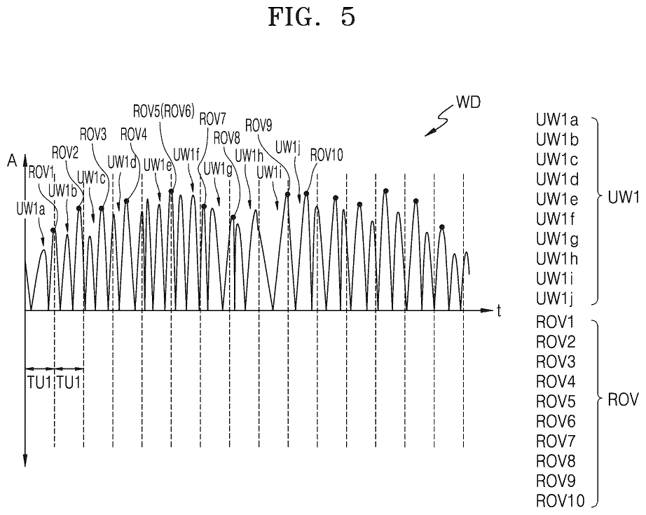

FIG. 5 is a diagram for describing the extracting of the calculated representative value ROV of the waveform signal WD shown in FIG. 3 (operation S200).

Referring to FIG. 5, in the extracting of the calculated representative value ROV based on the waveform signal WD (operation S200), the control device 200 may extract one calculated representative value ROV from each of a plurality of first unit waveforms UW1 included in the waveform signal WD in a first time unit TU1.

In the present specification, the first unit waveform UW1 may be a portion of the waveform signal WD included in the first time unit TU1.

The first time unit TU1 may be a smaller time unit than a second time unit TU2 described below. For example, the first time unit TU1 may be 0.02 seconds to 0.4 seconds or 0.04 seconds to 0.12 seconds.

The control device 200 may extract the calculated representative value ROV from each of the first unit waveforms UW1 and, thus, the control device 200 may diagnose an abnormal state of the equipment RF by using only at least one calculated representative value ROV which is included in the waveform signal WD in the first time unit TU1.

Accordingly, a size of data stored in the control device 200 or a size of data to be calculated by the control device 200 to diagnose an abnormal state of the equipment RF may be reduced.

In present specification, among the plurality of first unit waveforms UW1 in the plurality of first time units TU1, the plurality of first unit waveforms UW1 are sequentially defined as a 1a unit waveform UW1a, a 1b unit waveform UW1b, a 1c unit waveform UW1c, a 1d unit waveform UW1d, a 1e unit waveform UW1e, a 1f unit waveform UW1 f, a 1g unit waveform UW1g, a 1h unit waveform UW1h, a 1i unit waveform UW1i, and a 1j unit waveform UW1j.

The control device 200 may extract at least one calculated representative value ROV from each of the first unit waveforms UW1 in each of the first time unit TU1, and the control device 200 may extract the calculated representative value ROV as a constant greater than or equal to 0.

In the present specification, the calculated representative value ROV extracted from the 1a unit waveform UW1a is defined as a first calculated representative value ROV1, the calculated representative value ROV extracted from the 1b unit waveform UW1b is defined as a second calculated representative value ROV2, the calculated representative value ROV extracted from the 1c unit waveform UW1c is defined as a third calculated representative value ROV3, the calculated representative value ROV extracted from the 1d unit waveform UW1d is defined as a fourth calculated representative value ROV4, the calculated representative value ROV extracted from the 1e unit waveform UW1e is defined as a fifth calculated representative value ROV5, the calculated representative value ROV extracted from the 1f unit waveform UW1f is defined as a sixth calculated representative value ROV6, the calculated representative value ROV extracted from the 1g unit waveform UW1g is defined as a seventh calculated representative value ROV7, the calculated representative value ROV extracted from the 1h unit waveform UW1h is defined as an eighth calculated representative value ROV8, the calculated representative value ROV extracted from the 1i unit waveform UW1i is defined as a ninth calculated representative value ROV9, and the calculated representative value ROV extracted from the 1j unit waveform UW1j is defined as a tenth calculated representative value ROV10.

In the extracting of the calculated representative value ROV (operation S200), the control device 200 may extract the calculated representative value ROV by using a size of each first unit waveform UW1.

For example, the control device 200 may extract a maximum value of the first unit waveform UW1 as the calculated representative value ROV.

Referring to FIG. 5, because a maximum value of the 1a unit waveform UW1a is less than a maximum value of the 1b unit waveform UW1b, the control device 200 may extract the first calculated representative value ROV1 as a value less than the second calculated representative value ROV2, and because a maximum value of the 1g unit waveform UW1g is more than a maximum value of the 1h unit waveform UW1h, the control device 200 may extract the seventh calculated representative value ROV7 as a value relatively greater than the eighth calculated representative value ROV8.

In an embodiment, the control device 200 may extract a kurtosis value of the first unit waveform UW1 as the calculated representative value ROV.

In an embodiment, the control device 200 may extract an average value of the amplitudes of the first unit waveform UW1 as the calculated representative value ROV.

In an embodiment, the control device 200 may extract a vibration amount (overall) of the first unit waveform UW1 as the calculated representative value ROV.

In an embodiment, the control device 200 may extract a root mean square (RMS) of the first unit waveform UW1 as the calculated representative value ROV.

In an embodiment, the control device 200 may extract an area between the first unit waveform UW1 and the x-axis as the calculated representative value ROV.

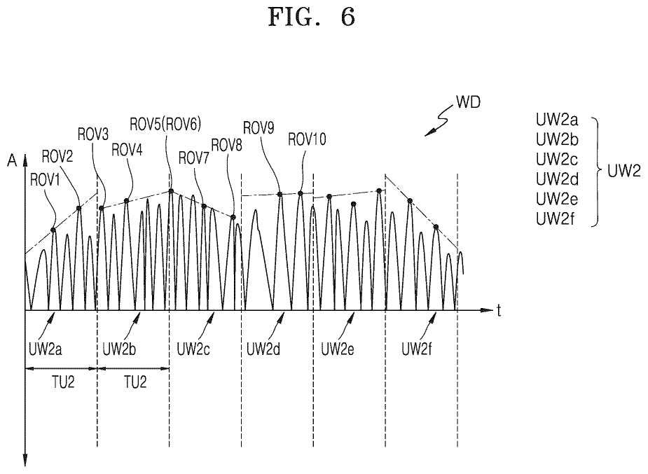

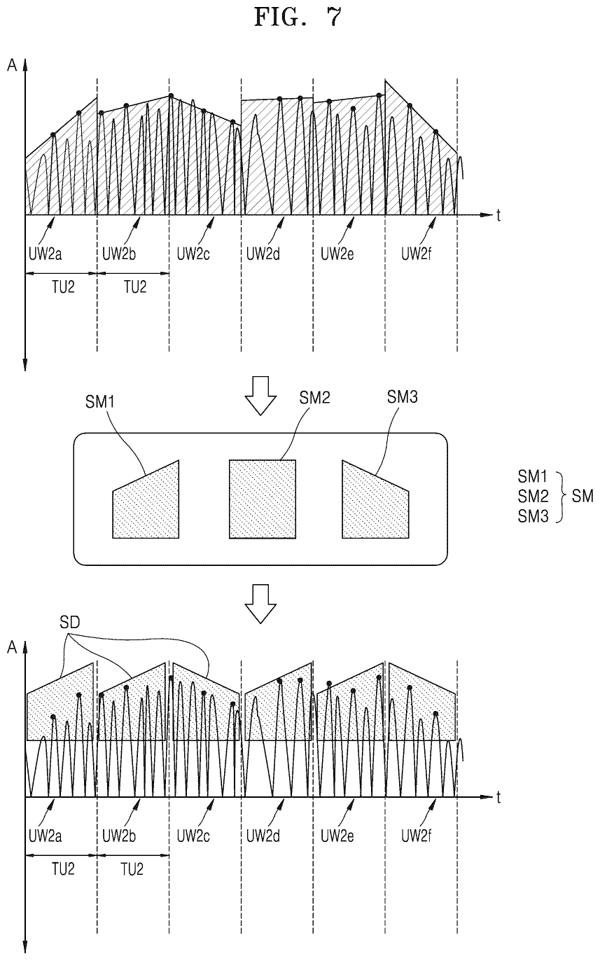

FIG. 6 is a diagram for describing a process of calculating a shape calculation function by using the calculated representative value ROV and FIG. 7 is a diagram for describing a process of selecting the shape data SD by using the shape calculation function.

Referring to FIG. 6, in the selecting of shape data SD (operation S300), the control device 200 may select the shape data SD corresponding to a plurality of second unit waveforms UW2 in the second time unit TU2.

In the present specification, each of the second unit waveforms UW2 may be a portion of the waveform signal WD included in each of the second time unit TU2.

The second time unit TU2 may be a greater time unit than the first time unit TU1. For example, the second time unit TU2 may be 0.05 seconds to 1 second or 0.01 seconds to 0.3 seconds.

The control device 200 may diagnose an abnormal state of the equipment RF by using only the shape data SD corresponding to each of the second unit waveforms UW2 in each of the second time unit TU2 and, accordingly, may reduce a size of data required to diagnose the abnormal state of the equipment RF by using only the shape data SD selected at intervals of 0.05 seconds to 0.3 seconds to diagnose the abnormal state of the equipment RF.

In the present specification, the plurality of second unit waveforms UW2, each of which is included in each of the second time unit TU2, may be sequentially defined as a 2a unit waveform UW2a, a 2b unit waveform UW2b, a 2c unit waveform UW2c, a 2d unit waveform UW2d, a 2e unit waveform UW2e, and a 2f unit waveform UW2f.

In the selecting of the shape data SD (operation S300), the control device 200 may select the shape data SD corresponding to the second unit waveform UW2 based on the calculated representative value ROV of the first unit waveform UW1 in the second unit waveform UW2.

For example, because the 2a unit waveform UW2a may temporally overlap the 1a unit waveform UW1a and the 2b unit waveform UW2b, the shape data SD of the 2a unit waveform UW2a may be calculated based on the first calculated representative value ROV1 and the second calculated representative value ROV2.

Also, because the 2b unit waveform UW2b may temporally overlap the 1c unit waveform UW1c, the 1d unit waveform UW1d, and the 2e unit waveform UW2e, the shape data SD of the 2b unit waveform UW2b may be calculated based on the third calculated representative value ROV3, the fourth calculated representative value ROV4, and the fifth calculated representative value ROV5.

Referring to FIG. 7, in the selecting of the shape data SD (operation S300), the control device 200 may select the shape data SD based on an average inclination of a line connecting the calculated representative values ROV of the first unit waveform UW1 that temporally overlaps the second unit waveform UW2.

In the selecting of the shape data SD (operation S300), the control device 200 may calculate the shape calculation function by using the calculated representative values ROV in the second unit waveform UW2 and the control device 200 may select the shape data SD by using the calculated shape calculation function.

The control device 200 may calculate a size of the plurality of calculated representative values ROV temporally overlapping the second unit waveform UW2 and the average inclination defined by a time interval as the shape calculation function of the second unit waveform UW2.

For example, the control device 200 may calculate, as the shape calculation function, a size of the plurality of calculated representative values ROV temporally overlapping the second unit waveform UW2 and a sign or a magnitude of the average inclination which is defined by the time interval.

In this case, the control device 200 may extract, as a shape calculation function of the 2a unit waveform UW2a, a sign or magnitude of an inclination of a line connecting the first calculated representative value ROV1 and the second calculated representative value ROV2, and the control device 200 may extract the shape calculation function of the 2a unit waveform UW2a as “+” or “+a”.

The “a” may be the magnitude of the inclination of the line connecting the first calculated representative value ROV1 and the second calculated representative value ROV2.

Also, the control device 200 may extract, as a shape calculation function of the 2c unit waveform UW2c, an average sign or an average magnitude of inclinations of a first line connecting the fifth calculated representative value ROV5 and the sixth calculated representative value ROV6 and a second line segment connecting the sixth calculated representative value ROV6 and the seventh calculated representative value ROV7, and the control device 200 may extract the shape calculation function of the 2c unit waveform UW2c as “−” or “−b”.

The “b” may be an average of the inclination of the first line and the inclination of the second line.

In the selecting of the shape data SD (operation S300), the control device 200 may select the shape data SD by comparing sizes of the plurality of calculated representative values ROV that are included in the same second unit waveform UW2 and temporally adjacent to each other.

For example, the control device 200 may calculate, as a shape calculation function of one second unit waveform UW2, a sign or a size of a value obtained by subtracting a temporally preceding calculated representative value ROV from a temporally following calculated representative value ROV among the plurality of calculated representative values ROV that are included in the one second unit waveform UW2 and temporally adjacent to each other.

In an embodiment, when the control device 200 extracts the size of the lower surface area of the first unit waveform UW1 as the calculated representative value ROV, the control device 200 may determine the shape calculation function as a difference between a plurality of calculated representative values ROV that are temporally overlapping with and simultaneously parallel to the second unit waveform UW2.

In this case, the control device 200 may calculate, as the shape calculation function, a sign or a size of a value obtained by subtracting a lower surface area of a temporally preceding first unit waveform UW1 from a lower surface area of a temporally following first unit waveform UW1 among the plurality of first unit waveforms UW1 that temporally overlap the second unit waveform UW2.

Referring to FIG. 7, in the selecting of the shape data SD (operation S300), the control device 200 may select the shape data SD by using the calculated shape calculation function.

For example, the plurality of shape models SM may be stored in the control device 200, and the control device 200 may select, as the shape data SD, a shape model SM corresponding to the shape calculation function calculated by using the calculated representative value ROV from among the stored plurality of shape models SM.

In an embodiment, the shape models SM may include three types, and, in this case, the shape models SM may include a first shape SM1 in which an inclination of an upper side is positive, a second shape SM2 in which an inclination of an upper side is 0, and a third shape SM3 in which an inclination of an upper side is negative.

In an embodiment, the shape models SM may include five types, and in this case, the shape models SM may include a first shape in which an inclination of an upper side is +a, a second shape in which an inclination of an upper side is +b, a third shape in which an inclination of an upper side is 0, a fourth shape in which an inclination of an upper side is −b, and a fifth shape in which an inclination of an upper side is −a.

However, the disclosure is not limited thereto, and the shape data SD may include various types of data within the technical scope which may represent a size of a shape calculation function and/or a sign of the shape calculation function such as a shape or a number.

The control device 200 may select the shape model SM corresponding to each of the shape calculation functions of the plurality of second unit waveforms UW2 as the shape data SD of each of the plurality of second unit waveforms UW2.

For example, the control device 200 may select the shape model SM corresponding to the sign of the shape calculation function of any second unit waveform UW2 as the shape data SD of the any second unit waveform UW2.

In an embodiment, the control device 200 may select the shape model SM corresponding to the size of the shape calculation function of any second unit waveform UW2 as the shape data SD of any second unit waveform UW2.

In the diagnosing of the abnormal state of the equipment RF (operation S400), the control device 200 may diagnose the abnormal state of the equipment RF by comparing the types of shape data SD of the plurality of second unit waveforms UW2 that are temporally adjacent to each other.

For example, the control device 200 may determine that the abnormal state of the equipment RF has occurred when the types of the shape data SD of the plurality of second unit waveforms UW2 that are temporally adjacent to each other are different from each other.

Referring to FIG. 7, the types of the shape data SD of the 2a unit waveform UW2a and the shape data SD of the 2b unit waveform UW2b are the same, but the types of the shape data SD of the 2b unit waveform UW2b and the shape data SD of the 2c unit waveform UW2c are different from each other, and, in this case, the control device 200 may determine that the abnormal state of the equipment RF has occurred.

In an embodiment, the control device 200 may count the number of times in which the types of the shape data SD of the plurality of second unit waveforms UW2 that are temporally adjacent to each other are different from each other, and the control device 200 may determine that the abnormal state of the equipment RF has occurred when the counted number of times exceeds a preset number of times.

An equipment abnormality diagnosis method, a control device, and an equipment abnormality diagnosis system including the same according to embodiments of the disclosure, diagnose an abnormal state of equipment by using a shape of a waveform signal obtained from the equipment and, thus, the abnormal state of the equipment may be effectively diagnosed with a relatively small amount of data.

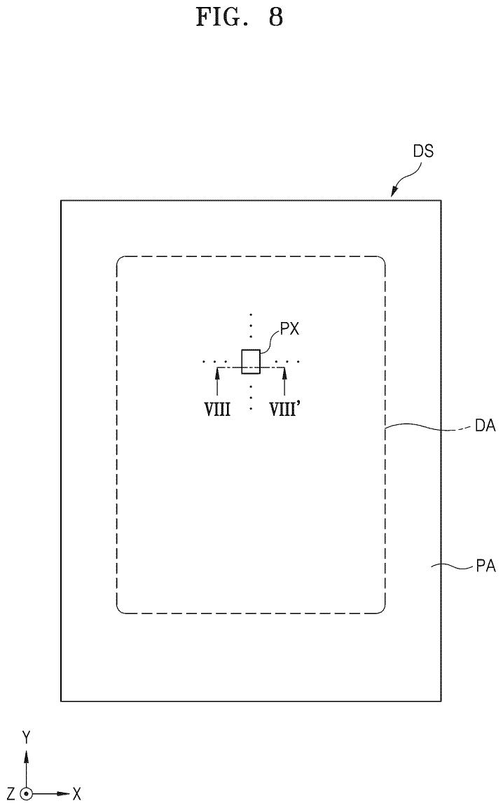

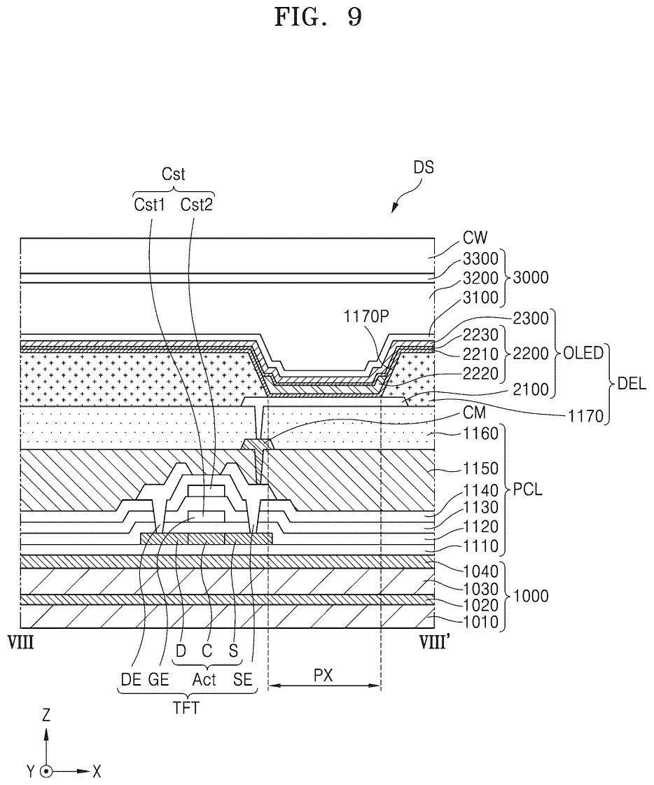

FIG. 8 is a diagram schematically illustrating the display device DS capable of being transferred to the equipment shown in FIG. 1, and FIG. 9 is a cross-sectional view of a sub-pixel of the display device DS of FIG. 8.

Referring to FIG. 8, the display device DS manufactured according to an embodiment of the disclosure may include a display area DA and a peripheral area PA located outside the display area DA. The display device DS may provide an image via an array of a plurality of pixels PX arranged in the display area DA in 2 dimensions and/or 3 dimensions.

The peripheral area PA is an area where an image is not provided, and may entirely or partially surround the display area DA. A driver or the like configured to provide an electrical signal or power to a pixel circuit corresponding to each pixel PX may be arranged in the peripheral area PA. A pad that is a region to which an electronic device or a printed circuit board may be electrically connected may be arranged in the peripheral area PA.

Hereinafter, the display device DS is described as including an organic light-emitting diode OLED as a light-emitting element, but the display device DS of the disclosure is not limited thereto.

In another embodiment, the display device DS may be an inorganic light-emitting display device including an inorganic light-emitting diode, i.e. The inorganic light-emitting diode may include a PN diode including inorganic semiconductor-based materials.

When a voltage is applied to a PN junction diode in a forward direction, holes and electrons are injected, and energy generated by recombination of the holes and electrons is converted into light energy, and, thus, light of a certain color may be emitted. The inorganic light-emitting diode may have a width of several to several hundred micrometers, and in some embodiments, the inorganic light-emitting diode may be referred to as a micro light-emitting diode (LED).

In another embodiment, the display device DS may be a quantum dot light-emitting display device.

The display device DS may be used as a display screen of not only to a portable electronic device, such as a mobile phone, a smartphone, a tablet personal computer (PC), a mobile communication terminal, an electronic notebook, an electronic book, a portable multimedia player (PMP), a navigation device, or an ultra-mobile PC (UMPC), but also to any one of various products, such as a television, a laptop computer, a monitor, a billboard, and an Internet of things (IoT) device.

Also, the display device DS according to an embodiment may be used for a wearable device, such as a smart watch, a watch phone, a glasses-type display, or a head mounted display (HMD).

In addition, the display device DS according to an embodiment may be used as a panel of a vehicle, a center information display (CID) arranged on a center fascia or dashboard of a vehicle, a room mirror display replacing a side mirror of a vehicle, or a display screen arranged on a rear surface of a front seat, as entertainment for a back seat of a vehicle.

Referring to FIG. 9, the display device DS may include a stack structure of a substrate 1000, a pixel circuit layer PCL, a display element layer DEL, and an encapsulation layer 3000.

The substrate 1000 may have a multi-layer structure including an inorganic layer and a base layer including polymer resin. For example, the substrate 1000 may include a barrier layer of an inorganic insulating layer and the base layer including the polymer resin.

For example, the substrate 1000 may include a first base layer 1010, a first barrier layer 1020, a second base layer 1030, and a second barrier layer 1040, which are sequentially stacked. The first base layer 1010 and the second base layer 1030 may include polyimide (PI), polyethersulfone (PES), polyarylate, polyetherimide (PEI), polyethyelenene napthalate (PEN), polyethyelene terepthalate (PET), polyphenylene sulfide (PPS), polycarbonate (PC), cellulose triacetate (TAC), and/or cellulose acetate propionate (CAP).

The first barrier layer 1020 and the second barrier layer 1040 may include an inorganic insulating material, such as silicon oxide, silicon oxynitride, and/or silicon nitride. The substrate 1000 may be flexible.

The pixel circuit layer PCL may be disposed on the substrate 1000. FIG. 9 illustrates that the pixel circuit layer PCL includes a thin-film transistor TFT, and a buffer layer 1110, a first gate insulating layer 1120, a second gate insulating layer 1130, an interlayer insulating layer 1140, a first planarization insulating layer 1150, and a second planarization insulating layer 1160, which are disposed below and/or above components of the thin-film transistor TFT.

The buffer layer 1110 may reduce or block penetration of foreign materials, moisture, or ambient air from a bottom portion of the substrate 1000 and may provide a flat surface on the substrate 1000.

The buffer layer 1110 may include an inorganic insulating material, such as silicon oxide, silicon oxynitride, or silicon nitride, and may have a single layer or multi-layer structure including such a material.

The thin-film transistor TFT on the buffer layer 1110 may include a semiconductor layer Act, and the semiconductor layer Act may include polysilicon.

Alternatively, the semiconductor layer Act may include amorphous silicon, an oxide semiconductor, or an organic semiconductor.

The semiconductor layer Act may include a channel region C, and a drain region D and a source region S which are arranged on opposite sides of the channel region C. A gate electrode GE may overlap the channel region C.

The gate electrode GE may include a low-resistance metal material. The gate electrode GE may include a conductive material including molybdenum (Mo), aluminum (Al), copper (Cu), or titanium (Ti), and may be formed in a multi-layer or single layer including the conductive material.

The first gate insulating layer 1120 between the semiconductor layer Act and the gate electrode GE may include an inorganic insulating material, such as silicon oxide (SiO₂), silicon nitride (SiN_{X}), silicon oxynitride (SiON), aluminum oxide (Al₂O₃), titanium oxide (TiO₂), tantalum oxide (Ta₂O₅), hafnium oxide (HfO₂), and/or zinc oxide (ZnOₓ). ZnOₓ may be ZnO and/or ZnO₂.

The second gate insulating layer 1130 may be provided to cover the gate electrode GE. Like the first gate insulating layer 1120, the second gate insulating layer 1130 may include an inorganic insulating material, such as SiO₂, SiN_{X}, SiON, Al₂O₃, TiO₂, Ta₂O₅, HfO₂, or ZnOₓ. ZnOₓ may be ZnO and/or ZnO₂.

An upper electrode Cst2 of a storage capacitor Cst may be arranged above the second gate insulating layer 1130. The upper electrode Cst2 may overlap the gate electrode GE below the upper electrode Cst2. Here, the upper electrode Cst2 and the gate electrode GE, which overlap each other with the second gate insulating layer 1130 between the upper electrode Cst2 and the gate electrode GE, may form the storage capacitor Cst. In other words, the gate electrode GE may function as a lower electrode Cst1 of the storage capacitor Cst.

As such, the storage capacitor Cst and the thin-film transistor TFT may overlap each other. According to some embodiments, the storage capacitor Cst may not overlap the thin-film transistor TFT.

The upper electrode Cst2 may include aluminum (Al), platinum (Pt), palladium (Pd), silver (Ag), magnesium (Mg), gold (Au), nickel (Ni), neodymium (Nd), iridium (Ir), chromium (Cr), calcium (Ca), molybdenum (Mo), titanium (Ti), tungsten (W), and/or copper (Cu), and may be a single layer or multi-layer including such a material.

The interlayer insulating layer 1140 may cover the upper electrode Cst2. The interlayer insulating layer 1140 may include SiO₂, SiN_{X}, SiON, Al₂O₃, TiO₂, Ta₂O₅, HfO₂, or ZnOₓ. ZnOₓ may be ZnO and/or ZnO₂. The interlayer insulating layer 1140 may be a single layer or multi-layer including the inorganic insulating material described above.

A drain electrode DE and a source electrode SE may each be disposed on the interlayer insulating layer 1140. The drain electrode DE and the source electrode SE may be respectively connected to the drain region D and the source region S through contact holes in insulating layers below the drain electrode DE and the source electrode SE. The drain electrode DE and the source electrode SE may include a material having good conductivity. The drain electrode DE and the source electrode SE may include a conductive material including Mo, Al, Cu, or Ti, and may be formed in a multi-layer or single layer including the above material. In an embodiment, the drain electrode DE and the source electrode SE may have a multi-layer structure of Ti/Al/Ti.

The first planarization insulating layer 1150 may cover the drain electrode DE and the source electrode SE. The first planarization insulating layer 1150 may include an organic insulating material, such as a general-purpose polymer, for example, polymethylmethacrylate (PMMA) or polystyrene (PS), a polymer derivate having a phenol-based group, an acrylic-based polymer, an imide-based polymer, an arylether-based polymer, an amide-based polymer, a fluorine-based polymer, a p-xylene-based polymer, a vinyl alcohol-based polymer, or a blend thereof.

The second planarization insulating layer 1160 may be disposed on the first planarization insulating layer 1150. The second planarization insulating layer 1160 may include a same material as the first planarization insulating layer 1150, and may include an organic insulating material, such as a general-purpose polymer such as polymethylmethacrylate (PMMA) or polystyrene (PS), a polymer derivative having a phenol group, an acryl-based polymer, an imide-based polymer, an arylether-based polymer, an amide-based polymer, a fluorine-based polymer, a p-xylene-based polymer, a vinyl alcohol-based polymer, or a blend thereof.

The display element layer DEL may be disposed on the pixel circuit layer PCL having the above-described structure. The display element layer DEL includes the organic light-emitting diode OLED as a display element (i.e., a light-emitting element), and the organic light-emitting diode OLED may have a stack structure of a pixel electrode 2100, an intermediate layer 2200, and a common electrode 2300. The organic light-emitting diode OLED may emit, for example, red, green, or blue light or red, green, blue, or white light. The organic light-emitting diode OLED emits a light through an emission area and the emission area may be defined by an opening 1170P in a pixel defining layer 1170.

The pixel electrode 2100 of the organic light-emitting diode OLED may be electrically connected to the thin-film transistor TFT through a contact metal CM disposed over the first planarization insulating layer 1150 and a source electrode SE disposed under the first planarization insulating layer 1150.

The pixel electrode 2100 may include a conductive oxide, such as indium tin oxide (ITO), indium zinc oxide (IZO), zinc oxide (ZnO), indium oxide (In₂O₃), indium gallium oxide (IGO), or aluminum zinc oxide (AZO). In another embodiment, the pixel electrode 2100 may include a reflective layer including Ag, Mg, Al, Pt, Pd, Au, Ni, Nd, Ir, Cr, or a compound thereof. In another embodiment, the pixel electrode 2100 may further include a layer formed of ITO, IZO, ZnO, or In₂O_{3,} on/below the reflective layer.

A pixel-defining layer 1170 having an opening 1170P in an area corresponding to a center portion of the pixel electrode 2100 may be arranged on the pixel electrode 2100. The pixel-defining layer 1170 may include an organic insulating material and/or an inorganic insulating material. The opening 1170P may define an emission area of a light emitted from the organic light-emitting diode OLED. For example, a size/width of the opening 1170P may correspond to a size/width of the emission area. Accordingly, a size and/or a width of the emission area may be dependent on a size and/or a width of the opening 1170P of the corresponding pixel-defining layer 1170.

The intermediate layer 2200 may include an emission layer 2220 formed in an area corresponding to the pixel electrode 2100. The emission layer 2220 may include a high-molecular weight organic material or low-molecular weight organic material, which emit light of a certain color. Alternatively, the emission layer 2220 may include an inorganic light-emitting material or a quantum dot.

In an embodiment, the intermediate layer 2200 may include a first functional layer 2210 and a second functional layer 2230, which are respectively disposed below and on the emission layer 2220. The first functional layer 2210 may include, for example, a hole transport layer (HTL) and/or a hole injection layer (HIL). The second functional layer 2230 is a component disposed on the emission layer 2220, and may include an electron transport layer (ETL) and/or an electron injection layer (EIL). Like the common electrode 2300 described below, the first functional layer 2210 and/or the second functional layer 2230 may be a common layer formed to entirely cover the substrate 1000.

The common electrode 2300 may be disposed on the pixel electrode 2100 and overlap the pixel electrode 2100. The common electrode 2300 may include a conductive material with a low work function. For example, the common electrode 2300 may include a (semi-)transparent layer including Ag, Mg, Al, Pt, Pd, Au, Ni, Nd, Ir, Cr, lithium (Li), calcium (Ca), or an alloy thereof. Alternatively, the common electrode 2300 may further include a layer including ITO, IZO, ZnO, or In₂O₃, on the (semi-)transparent layer including such a material. The common electrode 2300 may be integrally formed to entirely cover the substrate 1000.

The encapsulation layer 3000 may be disposed on the display element layer DEL and cover the display element layer DEL. The encapsulation layer 3000 includes at least one inorganic encapsulation layer and at least one organic encapsulation layer, and according to an embodiment, FIG. 9 illustrates that the encapsulation layer 3000 includes a first inorganic encapsulation layer 3100, an organic encapsulation layer 3200, and a second inorganic encapsulation layer 3300 which are sequentially stacked on each other.

The first inorganic encapsulation layer 3100 and second inorganic encapsulation layer 3300 may include one or more inorganic materials from among aluminum oxide, titanium oxide, tantalum oxide, hafnium oxide, zinc oxide, silicon oxide, silicon nitride, and silicon oxynitride. The organic encapsulation layer 3200 may include a polymer-based material. Examples of the polymer-based material may include an acrylic resin, an epoxy resin, polyimide, and polyethylene. In an embodiment, the organic encapsulation layer 3200 may include acrylate. The organic encapsulation layer 3200 may be formed by curing monomer or applying polymer. The organic encapsulation layer 3200 may be transparent.

Although not illustrated, a touch sensor layer may be arranged on the encapsulation layer 3000, and an optical functional layer may be arranged on the touch sensor layer. The touch sensor layer may obtain coordinate information according to an external input, for example, a touch event. The optical functional layer may reduce reflectance of a light (external light) incident from the outside towards a display device DS, and/or enhance color purity of a light emitted from the display device DS. In an embodiment, the optical functional layer may include a retarder and/or a polarizer. The retarder may be a film type or liquid crystal coating type, and may include a λ/2 retarder and/or a λ/4 retarder. The polarizer may also be a film type or a liquid crystal coating type. The film type may include an elongated synthetic resin film, and the liquid crystal coating type may include liquid crystals arranged in a certain arrangement. The retarder and the polarizer may further include a protection film.

An adhesive member may be arranged between the touch sensor layer and the optical functional layer. A general adhesive member known in the related art may be employed as the adhesive member without limitation. The adhesive member may be a pressure sensitive adhesive (PSA).

A cover window CW may be disposed on the encapsulation layer 3000, and when the touch sensor layer and/or the optical function layer are provided, may be disposed on a top portion of the touch sensor layer and/or the optical functional layer. The cover window CW may include at least one of glass, sapphire, or plastic. The cover window CW may be, for example, ultra-thin glass or colorless polyimide. In an embodiment, the cover window CW may have a structure in which a flexible polymer layer is arranged on one surface of a glass substrate or may include only a polymer layer.

The cover window CW may be attached by using an adhesive member (not shown). The adhesive member may be a liquid optically clear resin (OCR) or an optically clear adhesive (OCA) and/or a pressure sensitive adhesive (PSA).

An equipment abnormality diagnosis method, a control device, and an equipment abnormality diagnosis system including the same, according to embodiments of the disclosure, diagnose an abnormal state of equipment by using a shape of a waveform signal obtained from the equipment, and thus, the abnormal state of the equipment may be effectively diagnosed with a relatively small amount of data.

However, effects that are obtained through the disclosure are not limited to the effects described above, and other technical effects that are not mentioned will be clearly understood by one of ordinary skill in the art from the description of the disclosure.

Embodiments described above may be implemented independently, but it is obvious that a structure of each embodiment may be applied in combination to other embodiments.

The disclosure has been described with reference to the embodiments shown in the drawings, but the embodiments are only examples and it would be understood by one of ordinary skill in the art that various modifications and equivalent embodiments are possible. Accordingly, the scope of the disclosure will be defined by the appended claims.

Certain executions described in an embodiment are embodiments and do not limit the scope of the embodiment in any way. Also, elements described herein may not be essential elements for application of the disclosure unless the elements are particularly described as being “essential” or “critical”.

The term “the” and similar referential terms in the specification (specifically in the claims) of an embodiment may be used for both the singular and the plural.

Further, when a range is described in an embodiment, the disclosure includes inventions to which individual values belonging to the range are applied (unless otherwise stated), and it is considered that each individual value configuring the range is described in the detailed description.

Lastly, unless an order is clearly stated or unless otherwise stated, operations configuring a method according to an embodiment may be performed in an appropriate order. An embodiment is not necessarily limited by an order the operations are described.

In an embodiment, the use of all examples or exemplary terms is merely for describing the embodiment in detail and the scope of the embodiment is not limited by those examples or exemplary terms unless defined in the claims.

Also, it would be obvious to one of ordinary skill in the art that various modifications, combinations, and changes may be configured according to design conditions and factors within the scope of claims or equivalents.

What is claimed is:

1. An equipment abnormality diagnosis method comprising:
obtaining a waveform signal from a sensor unit configured to detect vibration of equipment to be diagnosed;
extracting a calculated representative value based on the waveform signal;
selecting a shape data corresponding to the calculated representative value by using a plurality of pre-stored shape models; and
diagnosing an abnormal state of the equipment based on a type of the selected shape data.

2. The equipment abnormality diagnosis method of claim 1, wherein the extracting of the calculated representative value comprises extracting at least calculated representative value from each of a plurality of first unit waveforms included in the waveform signal in a first time unit.

3. The equipment abnormality diagnosis method of claim 2, wherein the at least calculated representative value is greater than or equal to 0.

4. The equipment abnormality diagnosis method of claim 2, wherein the extracting of the calculated representative value comprises extracting the calculated representative value by using a size of each of the plurality of first unit waveforms.

5. The equipment abnormality diagnosis method of claim 2, wherein the selecting of the shape data comprises selecting one shape data corresponding to each of a plurality of second unit waveforms included in the waveform signal in a second time unit.

6. The equipment abnormality diagnosis method of claim 5, wherein the second time unit is relatively greater than the first time unit.

7. The equipment abnormality diagnosis method of claim 5, wherein the selecting of the shape data comprises selecting one shape data corresponding to the each of the plurality of second unit waveforms, based on the calculated representative value of the plurality of first unit waveforms temporally overlapping the plurality of second unit waveforms.

8. The equipment abnormality diagnosis method of claim 5, wherein the selecting of the shape data comprises selecting the shape data by comparing sizes of a plurality of calculated representative values that are temporally adjacent to each other and included in a same second unit waveform.

9. The equipment abnormality diagnosis method of claim 1, wherein the diagnosing of the abnormal state of the equipment comprises diagnosing the abnormal state of the equipment by comparing types of the shape data of the plurality of second unit waveforms that are temporally adjacent to each other.

10. The equipment abnormality diagnosis method of claim 9, wherein the diagnosing of the abnormal state of the equipment comprises determining that the abnormal state has occurred in the equipment when the types of the shape data of the plurality of second unit waveforms that are temporally adjacent to each other are different from each other.

11. A control device comprising:
at least one memory; and
at least one processor,
wherein the at least one processor is configured to obtain a waveform signal from a sensor unit configured to detect vibration of equipment to be diagnosed, extract a calculated representative value based on the waveform signal, select a shape data corresponding to the calculated representative value by using a plurality of pre-stored shape models, and diagnose an abnormal

12. The control device of claim 11, wherein the at least one processor is further configured to extract at least calculated representative value from each of a plurality of first unit waveforms included in the waveform signal in a first time unit.

13. The control device of claim 12, wherein the at least one processor is further configured to extract the calculated representative value by using a size of each of the plurality of first unit waveforms.

14. The control device of claim 12, wherein the at least one processor is further configured to select one shape data corresponding to each of a plurality of second unit waveforms included in the waveform signal in a second time unit.

15. The control device of claim 11, wherein the at least one processor is further configured to diagnose the abnormal state of the equipment by comparing types of the shape data of the plurality of second unit waveforms that are temporally adjacent to each other.

16. An equipment abnormality diagnosis system comprising:
equipment configured to transfer and/or return all or a portion of an electronic device;
a sensor unit configured to detect vibration of the equipment to be diagnosed; and
a control device configured to obtain a waveform signal including information about the vibration of the equipment from the sensor unit and diagnose an abnormal state of the equipment,
wherein the control device is further configured to obtain the waveform signal from the sensor unit, extract a calculated representative value based on the waveform signal, select a shape data corresponding to the calculated representative value by using a plurality of pre-stored shape models, and diagnose the abnormal state of the equipment based on a type of the selected shape data.

17. The equipment abnormality diagnosis system of claim 16, wherein the control device is further configured to extract at least calculated representative value from each of a plurality of first unit waveforms included in the waveform signal in a first time unit.

18. The equipment abnormality diagnosis system of claim 17, wherein the control device is further configured to extract the calculated representative value by using a size of each of the plurality of first unit waveforms.

19. The equipment abnormality diagnosis system of claim 17, wherein the control device is further configured to select one shape data corresponding to each of a plurality of second unit waveforms included in the waveform signal in a second time unit.

20. The equipment abnormality diagnosis system of claim 16, wherein the control device is further configured to diagnose the abnormal state of the equipment by comparing types of the shape data of the plurality of second unit waveforms that are temporally adjacent to each other.
